(19) United States
(12) Patent Application Publication
(10) Pub. No.: US 2002/0008932 A1
(43) Pub. Date: Jan. 24, 2002

(54) GATEWAY ACTUATOR

(76) Inventors: BRENT R. BATEMAN, SAN RAMON, CA (US); ROBERT HOPPE, BOULDER CREEK, CA (US); SHRIKANT M. DESAI, LIVERMORE, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/233,691

(22) Filed: Jan. 19, 1999

Related U.S. Application Data
(60) Provisional application No. 60/071,913, filed on Jan. 20, 1998.

(51) Int. Cl. G11B 15/00

(52) U.S. Cl. 360/96.5

(57) ABSTRACT

An actuation assembly (100) used with a removable hard disk drive system. The assembly uses various mechanisms interconnected to cooperate in the manner which permits manipulation of various mechanical members of an external drive system (10). The disk drive has a housing (10) with a receptacle (150) which removably receives a cartridge (60). The housing further has a cover (12) formed of a cover material and a front loading access panel (14) disposed over the receptacle. The actuation assembly (100) has at least one hub assembly (110) and a mechanical member (120) comprising an alloy material which contracts to produce a force which actuates pivotal movement of the hub assembly around an axis of rotation.

This application is a continuation-in-part of provisional Application Ser. No. 60/071,913 (Attorney Docket No. 18525-002700), filed Jan. 20, 1998, the full disclosure of which is herein incorporated by reference.

### BACKGROUND OF THE INVENTION

The present invention is generally related to recording systems, in particular, provides methods and assemblies for manipulating components of a disk drive system.

Video Cassette Recorders (“VCRs”) dominate the consumer video market, due in part to their combination of low cost and recording capabilities. VCR analog magnetic tape recording cassettes can be used to record, play-back, and store video images in a format which is well adapted for use with existing analog television signals. The ability to record allows consumers to use the standard VHS VCR to save television shows and home movies, as well as for play-back of feature films.

The structure of VCR systems and recording media is adapted to record and archive existing television signals. Specifically, a large amount of analog data is presented on a standard television screen during a standard length feature film. VCR systems record this analog data using analog recording media. The VCR recordings can be removed from the recording/play-back equipment for storage, thereby reducing the system costs when large numbers of movies are stored.

While VCR systems successfully provide recording and archive capabilities at low cost, these existing consumer video systems have significant disadvantages. For example, accessing selected portions of a movie stored on a VCR tape can be quite slow and cumbersome. In particular, the cassette must be rewound to the beginning of the movie between each showing, which can involve a considerable delay. Additionally, transferring data to and from the tape takes a substantial amount of time. Although it would be beneficial to provide high speed accessing and transfer of the video data, this has remained a secondary consideration, as movies are typically recorded and played by the consumer in real time. Alternatives providing faster access are commercially available (for example, optical video disks), but these alternatives generally have not been able to overcome the VCR's low cost and recording capabilities.

Recent developments in video technology may further decrease the VCR's advantages over alternative systems. Specifically, standard protocols have recently been established for High Definition TeleVision (“HDTV”) signals. The digital data presented in a single HDTV feature film using these protocols can represent a substantial increase over existing VCR system capacities. While digital video cassette tapes are available, these modified versions of existing analog VCR systems do not appear to have sufficient storage capacity for a feature film in all of the proposed HDTV formats. Optical disks can accommodate these larger quantities of digital data. Unfortunately, despite many years of development, a successful low cost optical recording system has remained an elusive goal.

Personal computer magnetic data storage systems have evolved with structures which are quite different than consumer video storage systems. Modern personal computers often include a rigid magnetic disk which is fixed in an associated disk drive. These hard disk drive systems are adapted to access and transfer data to and from a recording surface of the disk at high speeds. It is generally advantageous to increase the total data storage capacity of each hard disk, as the disks themselves are typically fixed in the drive system. Hence, much of the data that is commonly used by the computer is stored on a single disk.

The simplicity provided by such a fixed disk drive system helps maintain overall system reliability, and also helps reduce the overall storage system costs. Nonetheless, removable hard disk cartridge systems have recently become commercially available, and are now gaining some acceptance. While considerable computer data can be stored using these removable hard disk cartridge systems, their complexity, less than ideal reliability, and cost has limited their use to selected numbers of high-end personal computer users.

One particular disadvantage of known removable hard disk computer storage systems is the complexity of the structure used to ensure that the internal working mechanisms of the disk drive system are free from environmental contamination and external interference. The disk drive system door must be actuated with sufficient strength such that the door can be opened and remain opened for a period long enough to allow a user to insert a removable cartridge. Known removable disk drive doors are generally actuated by incorporating spring, solenoid, or motor driven actuators or other biasing mechanisms. These structures typically have large space and power requirements, and are usually complex. Moreover, these structures can increase the manufacturing complexity and cost of the disk drive system.

For these reasons, a door actuator mechanism is neded tha will overcome at least some of the above mentioned disadvantages.

### SUMMARY OF THE INVENTION

The invention provides assemblies and methods for manipulating components of a removable hard disk drive system. The invention uses mechanisms which are interconnected to cooperate in a manner which permits the manipulation of the components. The mechanisms are configured into an actuation assembly, which is used to cause the motion of, for example, the door of the external portion of the disk drive system. Specifically, the present invention moves the door with sufficient strength to open the door and allow it to remain open for a time period long enough to allow a user to insert or remove a disk cartridge. The actuation assembly includes a drive assembly which does not require a spring, solenoid, or motor as the primary actuating device. The large space and power quantities usually required by such devices is, therefore, substantially reduced. Since the present invention is simple in design and easy to manufacture, the overall cost of a disk drive system utilizing the actuation assembly is reduced.

Generally, the assembly includes a hinge device that can be made to rotate radially about or axially along a longitudinal axis. The hinge is coupled to an access panel, which is mounted on the housing of a disk drive system. As the hinge is made to rotate about a pivot point, the access panel is urged open or closed. To rotate the hinge, a driving member is used which is made of a specialized alloy, which is capable of contracting or expanding when heated. The contraction (or expansion) sets up a pulling force in the driving member, which is coupled to the hinge, to provide the force necessary to urge open the access panel door. As long as the heat is maintained, the alloy sustains the pulling force and the door will remain open. As the driving member cools, the pulling force is diminished. A biasing mechanism is used, which is coupled to the hinge, to stretch the driving member back to its original, uncontracted position and shape. As the driving member is pulled back to its original position, the hinge is simultaneously counter-rotated, which causes the access door to return to its closed position.

In one embodiment, a hard disk drive has an actuation assembly and a housing, which has a receptacle which removably receives a cartridge. The housing also has a cover, formed of a cover material and a front loading panel disposed over the receptacle. The actuation assembly includes a hinge assembly and a drive assembly, where the drive assembly has an alloy member which is coupled to the hinge assembly. A power supply is provided which generates an electrical current, the current being used to sufficiently raise the temperature of the alloy member causing the alloy member to undergo an internal change in structure thereby producing a force set within the alloy member. The force is of sufficient magnitude to actuate movement of the hinge assembly.

In an alternative embodiment, the drive assembly may further include a cam assembly which has a cam rotatable between an initial position and first and second extended positions; a cam spring in slidable contact with a portion of the cam member surface, whereby the cam spring engages the portion of the cam member surface to locate the cam member in each of the three positions; and a biasing member coupled to the cam member to return the alloy member back to the initial position following the removal of the alloy member force. The alloy member is made of a shape-memory alloy taken from a group of alloys which include products such as Nitinol™ and Flexinol™.

In another aspect, a method is provided for manipulating components of a removable hard disk drive. The removable hard disk drive having a housing which has a receptacle and removably receives a cartridge. The housing also has a cover, formed of a cover material and a front loading panel, disposed over the receptacle. The method includes selecting an alloy member which undergoes an internal change in structure when subjected to a change in temperature; generating an electrical current, the current used to sufficiently raise the temperature of the alloy member to produce a force set within the alloy member; and moving a component of the drive using the alloy member force.

In yet another aspect a method is provided which includes supplying energy to an alloy member causing the alloy member to undergo an internal change in structure thereby producing a force set within the alloy member; and actuating movement of an element by coupling said force to said element.

In yet another aspect, a method is provided for fabricating an actuation assembly for a hard disk drive having a housing which has a receptacle, which removably receives a cartridge, a cover formed of a cover material, and a front loading panel, disposed over the receptacle. The method includes selecting an alloy member, having a first end and a second end, which can undergo an internal change in structure, which produces a force within the alloy member; affixing the first end of the alloy member to a pivot assembly; and affixing the second end of the alloy member to a hinge mechanism, the hinge mechanism being coupled to a loading panel.

In yet another aspect, a disk drive system is provided for use with a removable disk cartridge. The disk drive system having a housing which has a receptacle, which removably receives the cartridge. The housing also having a cover formed of a cover material and a door. The door is coupled to an actuation assembly which includes a first arm coupled at a first end to the proximal end of a pivot shaft and coupled at a second end to the door; a second arm coupled at a first end to the distal end of a pivot shaft and coupled at a second end to a biasing mechanism; a shape-memory alloy wire mechanically coupled to the second end of the second arm and a position on the housing; a power supply activated by a switch positioned on the housing, wherein the power supply generates a current; and an electrical connection for applying the current to the wire, wherein the wire is heated by the current which causes the wire to contract generating a pulling force which is adapted to actuate the first and second arms.

### BRIEF DESCRIPTION OF THE DRAWINGS

FIG. 1 is a schematic illustration of a video system including a high definition television and an external disk drive.

FIG. 1A is a simplified perspective view of an external disk drive for use with a removable rigid recording disk cartridge, according to an embodiment of the present invention.

FIG. 1B is a simplified perspective view of an internal disk drive similar to the external drive of FIG. 1, in which the internal drive is adapted for insertion into a standard bay of a computer or other housing.

FIG. 1C is a simplified schematic side view of an actuation device of the present invention fully inserted into the external disk drive of FIG. 1A.

FIG. 2 is a simplified schematic view of an alternative embodiment of the present invention using a cam assembly.

FIGS. 2A-2C are simplified schematic views of the actuation assembly according to the alternative embodiment of FIG. 2 in operation.

FIG. 3 is a simplified schematic view of the actuation assembly according to an alternative embodiment of the present invention using a pivot rod assembly.

FIG. 4 is a perspective view of the internal disk drive of FIG. 1B, in which a cover of the disk drive has been removed to show a receptacle for the removable cartridge and some of the major disk drive components.

FIG. 5 is a perspective view of a removable cartridge housing a rigid magnetic recording disk.

FIG. 5A is an alternative perspective view of the cartridge of FIG. 5, showing the door and door actuation mechanism.

FIG. 6 is a simplified perspective view of the internal drive of FIG. 4, in which the voice coil motor and arm have been removed to show the cartridge release linkage and the head retract linkage.

FIG. 7A is a top view of a base for the internal drive of FIG. 4, in which the base is substantially entirely formed from sheet stock in a single stamping process.

FIG. 7B is a front view of the base of FIG. 7A.

FIG. 8A is a top view of the internal drive of FIG. 1B, in which the cover has been removed to show insertion of the cartridge of FIG. 5 therein.

FIG. 8B is a cross-sectional side view of the cartridge being inserted into the internal drive of FIG. 1B.

FIG. 9A is a cross-sectional side view of the cartridge of FIG. 5 fully inserted into the internal drive of FIG. 1B.

FIG. 9B is a top view of the cartridge inserted within the drive.

FIG. 9C is a perspective view of the disk drive housing cover, showing integral springs.

### DESCRIPTION OF THE SPECIFIC EMBODIMENTS

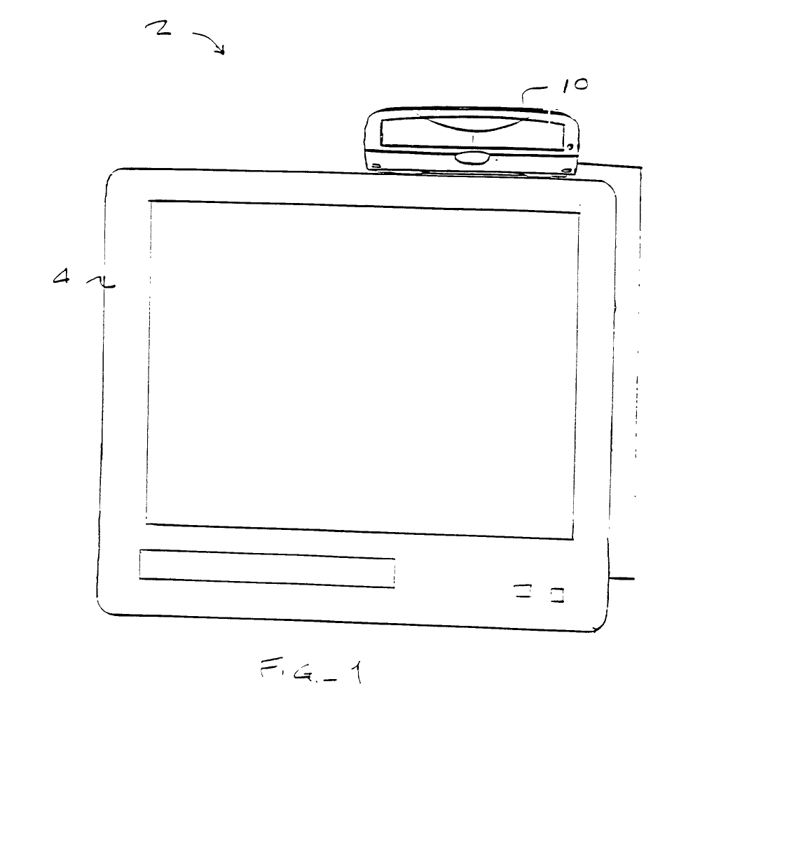

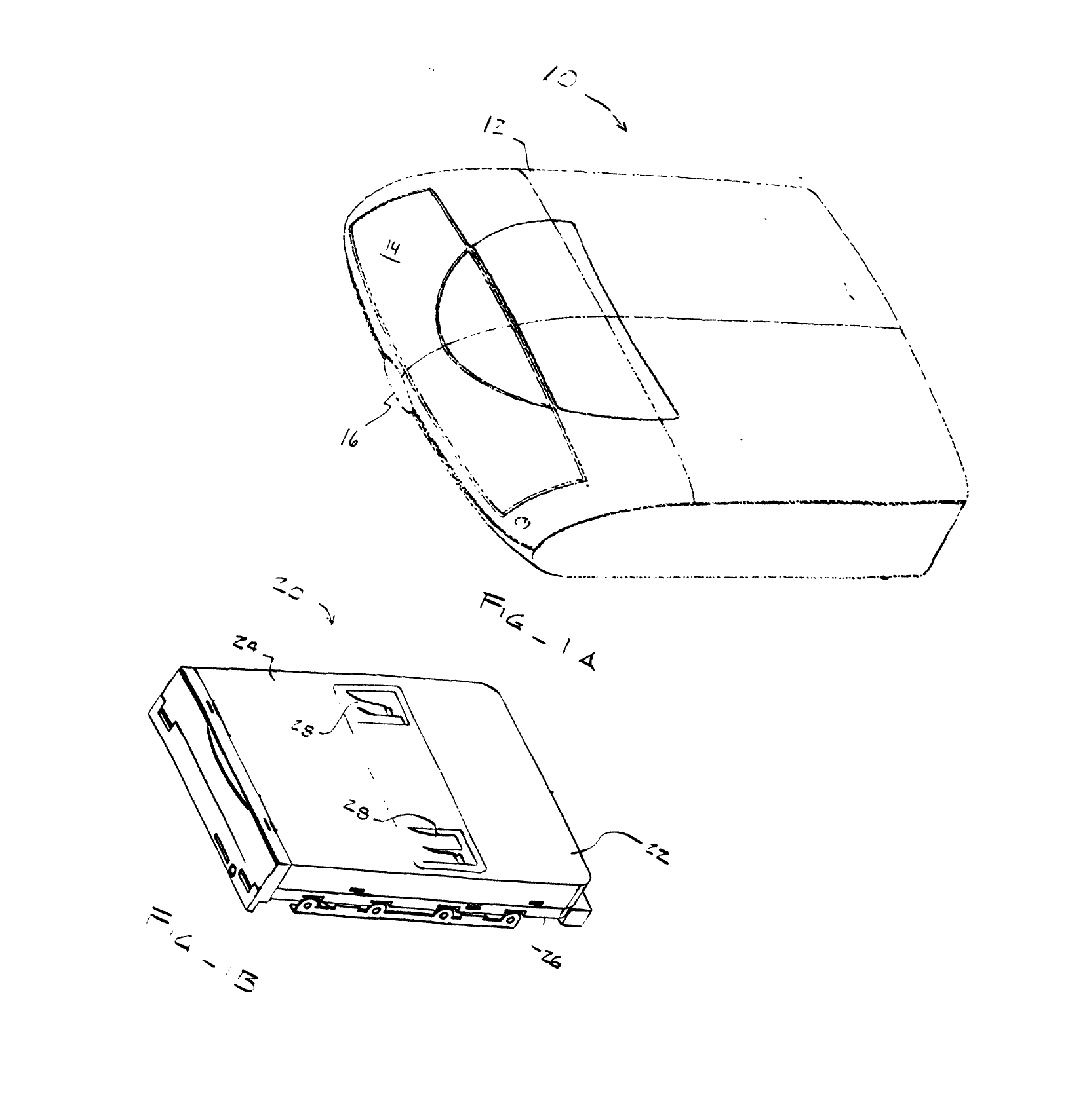

Referring now to FIGS. 1A and 1B, external disk drive 10 and internal disk drive 20 will share many of the same components. However, external drive 10 will include an enclosure 12 adapted for use outside a personal computer, high definition television, or some other data manipulation or display device. Additionally, external drive 10 will include standard I/O connectors, parallel ports, and/or power plugs similar to those of known computer peripheral or video devices.

Internal drive 20 will typically be adapted for insertion into a standard bay of a computer. In some embodiments, internal drive 10 may instead be used within a bay in a HDTV, thereby providing an integral video system. Internal drive 20 may optionally be adapted for use with a bay having a form factor of 2.4 inches, 1.8 inches, 1 inch, or with any other generally recognized or proprietary bay. Regardless, internal drive 20 will typically have a housing 22 which includes a housing cover 24 and a base plate 26. As illustrated in FIG. 1B, housing cover 24 will typically include integral springs 28 to bias the cartridge downward within the receiver of housing 22. It should be understood that while external drive 10 may be very different in appearance than internal drive 20, the external drive will preferably make use of base plate 26, cover 24, and most or all mechanical, electromechanical, and electronic components of internal drive 20. Should the internal drive be used with the external drive, a front loading access panel 14 is included on the housing to provide access to the internal drive 20 for loading of a cartridge 60.

As shown in FIG. 1C, an actuation assembly 100 is incorporated into an external drive 10. Assembly 100 combines mechanisms, interconnected to cooperate in a manner which creates movement of components of external drive 10.

Specifically, actuation assembly 100 includes a hinge assembly 126, which is coupled to access panel 14. Hinge assembly 126 is adapted so that it rotates about a pivot rod 130, which defines the axis of rotation for the hinge assembly. Actuation assembly 100 also includes drive assembly 110, which includes a drive member 120 and a biasing mechanism 135. When activated as described below, drive member 120 causes the rotation of hinge assembly 126. Biasing mechanism 135 is coupled to hinge assembly 126 and provides a mechanism for counter-rotating hinge assembly 126.

Hinge assembly 126 has, typically, a first mechanical arm 127 coupled at a first end to pivot rod 130 and coupled at a second end to access panel 14. Hinge assembly 126 also has a second mechanical arm 128 which is coupled at a first end to pivot rod 130 and coupled at a second end to biasing mechanism 135 and drive member 120. Mechanical arms 127 and 128 are in a fixed relationship with pivot rod 130 and therefore rotate about rod 130 in proportion with the rotation of rod 130. When a force is applied to pivot rod 130, from either drive member 120 or biasing mechanism 135, it rotates in either a clockwise or counter-clockwise direction, depending on the direction of the force applied. Mechanical arms 127 and 128, both being coupled to pivot rod 130, simultaneously rotate in the same direction. The first end of arm 127 coupled to access panel 14 rotates out of the housing through housing receptacle opening 150 to cause access panel 14 to rotate about its own hinge 134 until the access panel reaches a fully opened position.

The force used to drive pivot rod 130 and consequently to rotate arms 127 and 128 is generated within drive member 120. Drive member 120 is made of an alloy material which possess inherent shape-memory properties. The shape-memory alloy is capable of contracting or expanding, an ability characteristic of certain alloys which dynamically change their entire structures when exposed to an energy source. The energy source must be capable of raising the temperature of the alloy. The energy may be in the form of electrical, thermal, or any similar type of energy. The contracting (or expanding) of the member sets up a tensile (or compressive) force within the drive member. The present invention typically uses the member in contraction mode, but it can be configured such that the expansion mode is used. The contraction of the wire occurs in a manner opposite to ordinary thermal expansion and is both smooth and silent. The contraction of the alloy is more significant in magnitude then is thermal expansion in other metals. Advantageously, the alloy exerts a more powerful force in relation to its size than is realized in other materials. In operation, energy is supplied to drive member alloy 120. The alloy contracts which causes alloy 120 to shrink, creating a contraction force. One end of alloy drive member 120 is secured at a fixed point in the housing so that the work provided by the contraction force is applied solely to rotating pivot rod 130. The force causes pivot rod 130 to rotate which, in turn, causes hinge assembly 126 to also rotate. Since access panel 14 is coupled to arm 127 of hinge assembly 126 it is made to swing open about its own hinge 134.

Drive member 120 may take the form of a wire, flat ribbon, or other similar form, and is typically made of a known nickel-titanium (Ni—Ti) alloy, commonly referred to as a shape-memory alloy and commercially referred to as Nitinol™ or Flexinol™. As shown in Table 1, the contraction force can range from between 7 gms to 930 gms, depending primarily on the wire diameter. The energy supplied to the wire, generally, causes the wire to rise in temperature. The higher temperature typically being induced, for example, electrically. However, the alloy can be made to expand or contract if heated in various other manners, such as exposing the alloy to a heating element or to hot air. The shape-memory alloy may contract by several percent of its length and is easily stretched back to its original length as it cools back to a predetermined temperature. Heating and cooling of the wire occurs relatively quickly. For example, table 1 indicates that the contraction time of an Ni—Ti alloy wire is approximately 1 second, independent of the wire diameter, and a wire of 0.004″ diameter will return to its un-contracted state in between 0.4 to 0.8 seconds, depending on the temperature that the wire is finally elevated. The data provided in Table 1 are exemplary.

In a specific embodiment described here for exemplary purposes only, the present invention uses a drive wire 120 of a diameter between about 0.001″ and 0.010″, preferably between about 0.002″ and 0.006″. Wire 120 is heated to between approximately 70° C. and 100° C. The temperature makes the wire contract in approximately 1 to 2 seconds, however, 1 second is preferred. The quantity of force required in the wire is dictated by the weight of the door, the efficiency of the hinge, friction in the system, and other factors. However, the force can range from about 7 gms to 930 gms, preferably between about 80 gms to 330 gms, but the force is not limited to these ranges. When the energy source is removed from wire 120, the wire will cool which will return the wire back to its original length in approximately 0.05 seconds to 6.0 seconds.

TABLE 1

| | | | Approxi- | | | |
|---|---|---|---|---|---|---|
| | | | mate | | | |
| | Resis- | | Current at | | Off | Off |
| Diam- | tance | | Room | Contrac- | Time | Time |
| eter | Ohms/ | Maximum | Tempera- | tion | 70 C | 90 C |
| Size | Inch | Pull Force | ture | Time | Wire | Wire |
| .001″ | 45 | 7 gms | 20 mA | 1 sec | .1 sec | .06 sec |
| .002″ | 12 | 35 gms | 50 mA | 1 sec | .3 sec | .1 sec |
| .003″ | 5 | 80 gms | 100 mA | 1 sec | .5 sec | .2 sec |
| .004″ | 3 | 150 gms | 180 mA | 1 sec | .8 sec | .4 sec |
| .005″ | 1.8 | 230 gms | 250 mA | 1 sec | 1.6 sec | .9 sec |
| .006″ | 1.3 | 330 gms | 400 mA | 1 sec | 2 sec | 1.2 sec |
| .008″ | .8 | 590 gms | 610 mA | 1 sec | 3.5 sec | 2.2 sec |
| .010″ | .5 | 930 gms | 1000 mA | 1 sec | 5.5 sec | 3.5 sec |

The biasing mechanism 135, which is typically in the form of a spring which provides the force necessary to stretch alloy wire 120 back to its original length, while simultaneously counter-rotating hinge assembly 126. Biasing mechanism 135 is coupled to the second arm 128 of hinge assembly 126. The counter-rotating action reverses the movement of the rocker arms 127 and 128 and forces door 14 to close.

In the event that the contraction forces is greater than is necessary for moving door 14 or else if, for example, the access door 14 is prevented from opening, a biasing device 134, may be coupled between the end of alloy wire 120 and the point to which alloy wire 120 is secured in the housing. The biasing device 134 can absorb an excessive force exerted by alloy wire 120, thereby reducing the potential for damaging the actuation assembly or the disk drive system.

Although the heat of the wire is not expected to reach a temperature that would be damaging to the system, alloy wire 120 can be protected in a protective sheath, so as to protect the internal drive 20 or other components of the external drive. The protective sheath may be made of a heat absorbent material, such as the product Teflon™.

A pair of hinge assemblies can be used, each disposed at opposite ends of access panel 14 within external drive 10. The dual hinge assemblies provide a balanced force applied to the door 14 for improved operation. The two hinge assemblies may be operated by the force generated in one wire 120, simultaneously coupled to both assemblies or each assembly may have its own force generating wire 120 attached to it. In either case, the current provided by the power supply can be used for both assemblies.

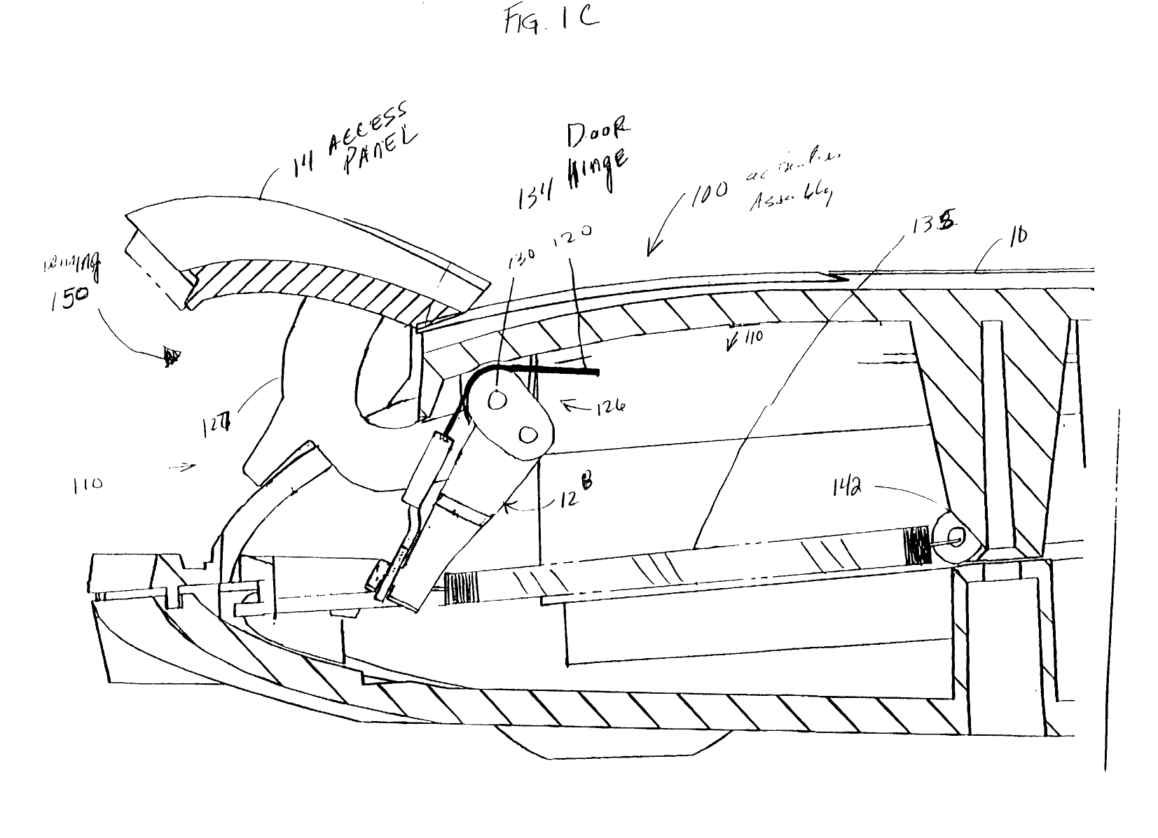

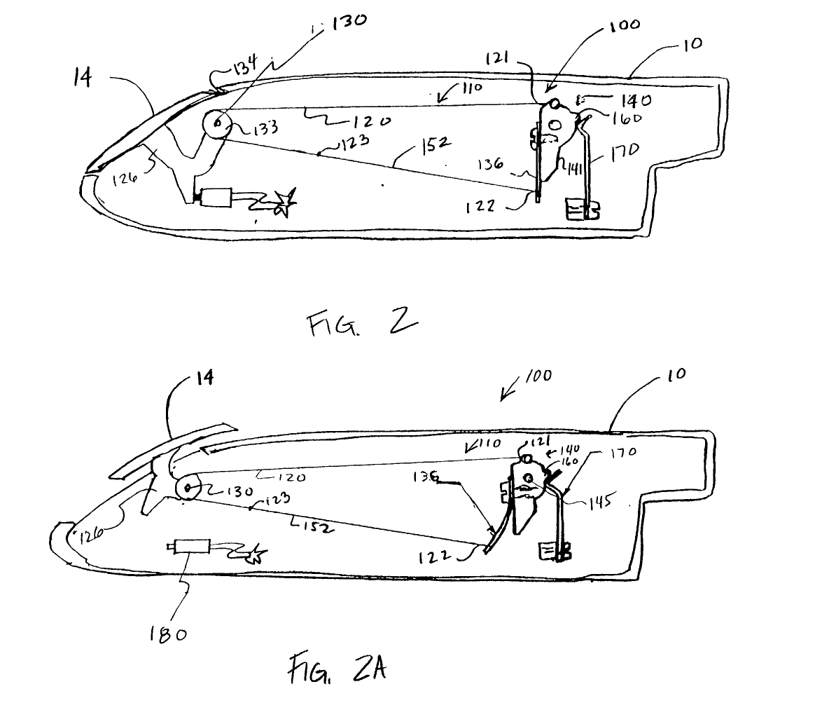

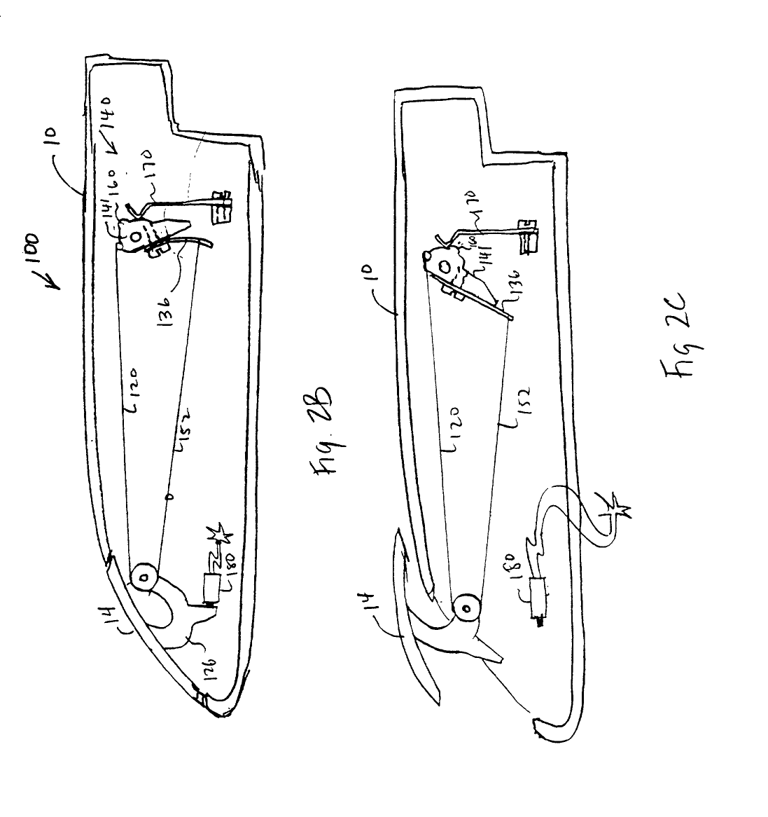

In an alternative embodiment, shown in FIG. 2, single hinge 126 is adapted to be coupled to pivot rod 130 and to access panel 14. On a portion of arm 126, a channel 133 is formed which receives drive member 120. A first end 121 of drive member 120 is coupled to a cam assembly 140. Cam assembly 140 includes cam 141, which has a raised bump portion 160, and biasing spring 136. Drive member 120 is wrapped around channel 133 and reconnected at a second end 122 to biasing spring 136. A portion of drive member 120 may be replaced between points 122 and 123 on drive member 120 with a cable 152. In this case, cable 152 may be attached to biasing spring 136 at attachment point 122. The cable makes it possible to lengthen the extent of drive member 120 without increasing the contraction force magnitude of the drive assembly.

The alternative embodiment of the present invention provides for varying modes of operation in which the disk drive system must function. FIG. 2A illustrates a first mode or normal mode of operation in which the actuation assembly opens access door 14. Drive member 120 is activated and operates as described above with regard to the force generated within the member. As drive member 120 contracts, cam assembly 140 provides an opposite reactive force such that the work produced by the contraction force is applied to hinge arm 126. Cam 141 is typically adapted to rotate about point 145, however, to ensure that cam 141 will not rotate clockwise in response to the application of the contraction force, a cam spring 170 is provided which slidably contacts cam 141 and abuts raised bump 160. Accordingly, hinge arm 126 rotates causing access door 14 to open the disk drive. After door 14 is opened to its fullest extent, the energy supplied to member 120 is maintained so that the temperature of the drive member 120 remains elevated and the door 14 will remain opened. To ensure that drive member 120 does not open door 14 beyond a predetermined amount, biasing spring 136, to which the second end 122 of drive member 120 or cable 152 is attached, absorbs the excess force. The excess force is stored in biasing spring 136 as potential spring energy and is used to counter-rotate hinge 126 at the appropriate time. A switch 180 is positioned in the disk drive which contacts door 14 in the closed position. When switch 180 is released, as when the door begins to rotate open, switch 180 senses the release and begins a clock timer which will indicate that the energy supplied to drive member 120 should be stopped after a predetermined time interval, allowing drive member 120 to cool and for the potential energy in spring 136 to counter-rotate access door 14 to close.

In a second mode of operation illustrated in FIG. 2B, it is anticipated that a user may attempt to close access door 14 manually before the energy supplied to drive member 120 has been deactivated so that the contraction force is still in full effect. Since the door is being forced to close, cam 141 rotates counter-clockwise allowing door 14 to close while maintaining the integrity of drive member 120. As door 14 closes it depresses witch 180 and the energy supply is removed. Cam 141 returns to its initial position, as shown in FIG. 2, by the potential energy stored in biasing spring 136.

In a third mode of operation illustrated in FIG. 2C, a user may attempt to manually open access door 14 while the activation system is deactivated. The force required to manually open door 14 will cause cam 141 to rotate in a clockwise direction. In this case, cam spring 170 slides over raised portion 160 and abuts the opposite side of the bump holding access door 14 open until drive member 120 is activated by switch 180 that senses when the door has been opened, and energizes drive member 120. The contraction force, not needed to open door 14, is directed to cam 141 to counter rotate cam 141 until cam spring 170 slides back over the bump and again abuts the bump at its initial position, as shown in FIG. 2. If at any time the door is open when the internal mechanisms of the disk drive are energized. Switch 180 will sense that door 14 is not closed. Drive member 120 will be energized for approximately 3 seconds, so that cam 141 can reset. Door 14 will then subsequently close.

In yet another alternative embodiment, as illustrated in FIG. 3, hinge 126 is adapted to be coupled to pivot rod 130 and to access panel 14. On a portion of arm 126, a channel 133 is formed which receives drive member 120. A first end 121 of drive member 120 is coupled to a pivot assembly 200. Pivot assembly 200 includes pivot bar 182, which pivots about a point 190, and biasing spring 187. Drive member 120 is wrapped around channel 133 and reconnected at a second end 122 to biasing spring 187.

Drive member 120 is energized and operates as described above with regard to the force generated within the member. As drive member 120 contracts, pivot assembly 200 provides an opposite reactive force through springs 185 and 186, such that the work produced by the contraction force is directed to hinge arm 126. Accordingly, hinge arm 126 rotates causing access door 14 to open the disk drive. After door 14 is opened to its fullest extent, the energy supplied to member 120 is maintained so that door 14 will remain opened. As before, to ensure that drive member 120 does not open door 14 beyond a predetermined amount, biasing spring 187, to which the second end 122 of drive member 120 or cable 152 is attached, absorbs the excess force. The excess force is stored in biasing spring 187 as potential spring energy and is used to counter-rotate hinge 126 to close door 14. The embodiment will also function in each of the modes of operation described above.

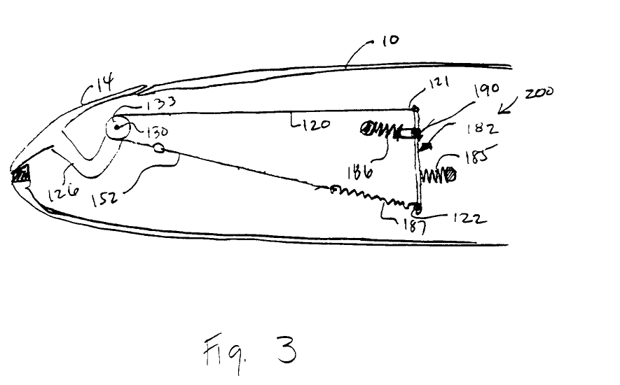

Many of the components of internal drive 20 are visible when cover 24 has been removed, as illustrated in FIG. 4. In this exemplary embodiment, a voice coil motor 30 positions first and second heads 32 along opposed recording surfaces of the hard disk while the disk is spun by spindle drive motor 34. A release linkage 36 is mechanically coupled to voice coil motor 30, so that the voice coil motor effects release of the cartridge from housing 22 when heads 32 move to a release position on a head load ramp 38. Head load ramp 38 is preferably adjustable in height above base plate 26, to facilitate aligning the head load ramp with the rotating disk.

A head retract linkage 40 helps to ensure that heads 32 are retracted from the receptacle and onto head load ramp 38 when the cartridge is removed from housing 22. Head retract linkage 40 may also be used as an inner crash stop to mechanically limit travel of heads 32 toward the hub of the disk.

Base 26 preferably comprise a stainless steel sheet metal structure in which the shape of the base is primarily defined by stamping, the shape ideally being substantially fully defined by the stamping process. Bosses 42 are stamped into base 26 to engage and accurately position lower surfaces of the cartridge housing. To help ensure accurate centering of the cartridge onto spindle drive 34, rails 44 maintain the cartridge above the associated drive spindle until the cartridge is substantially aligned axially above the spindle drive, whereupon the cartridge descends under the influence of cover springs 28 and the downward force imparted by the user. This brings the hub of the disk down substantially normal to the disk into engagement with spindle drive 34. A latch 46 of release linkage 36 engages a detent of the cartridge to restrain the cartridge, and to maintain the orientation of the cartridge within housing 22.

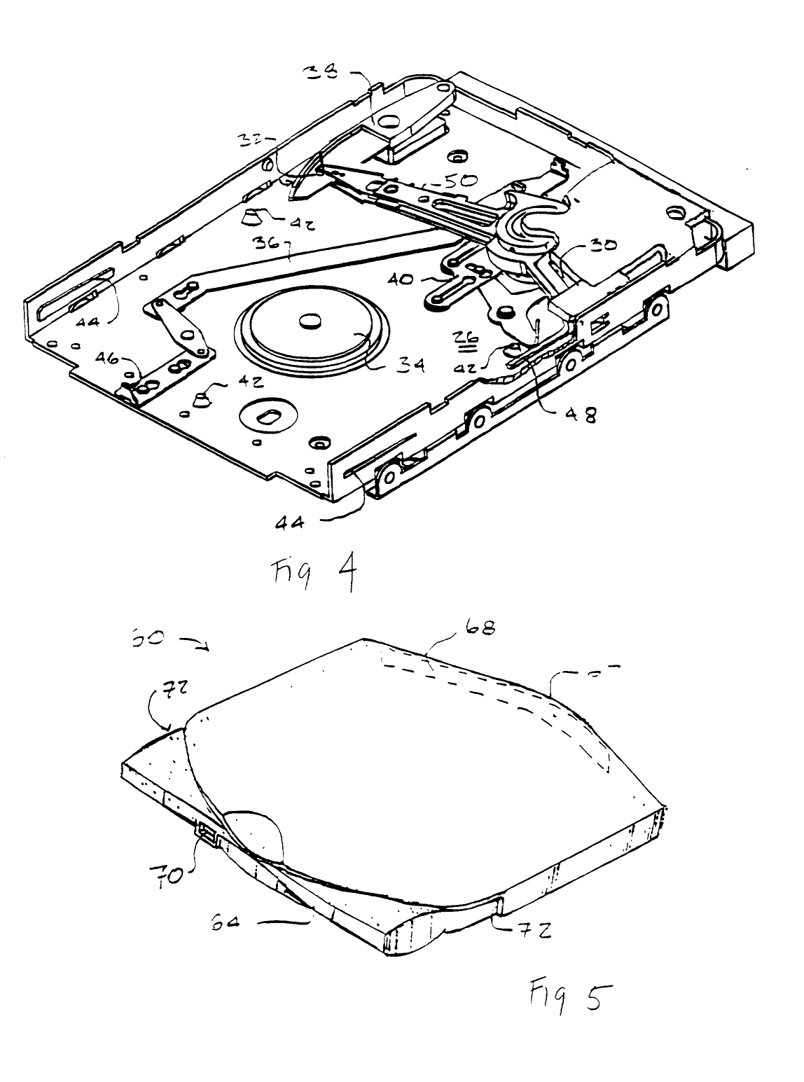

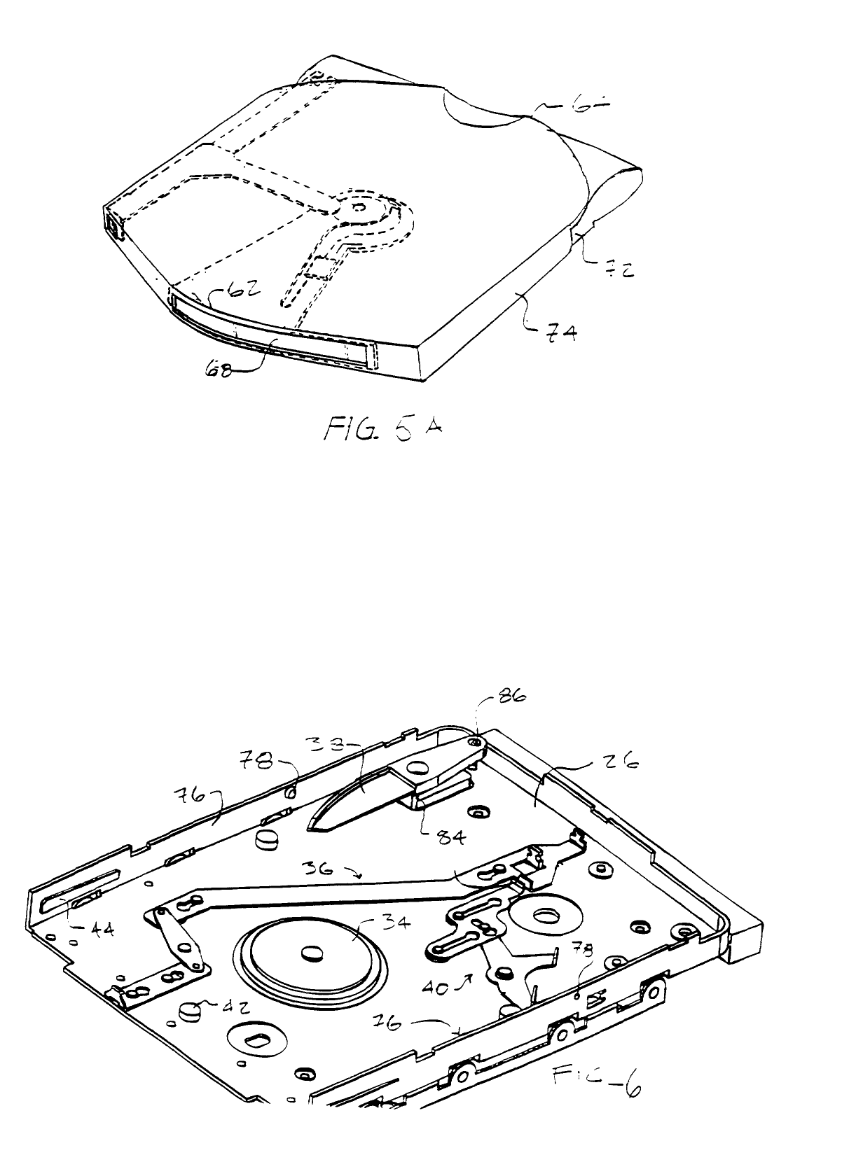

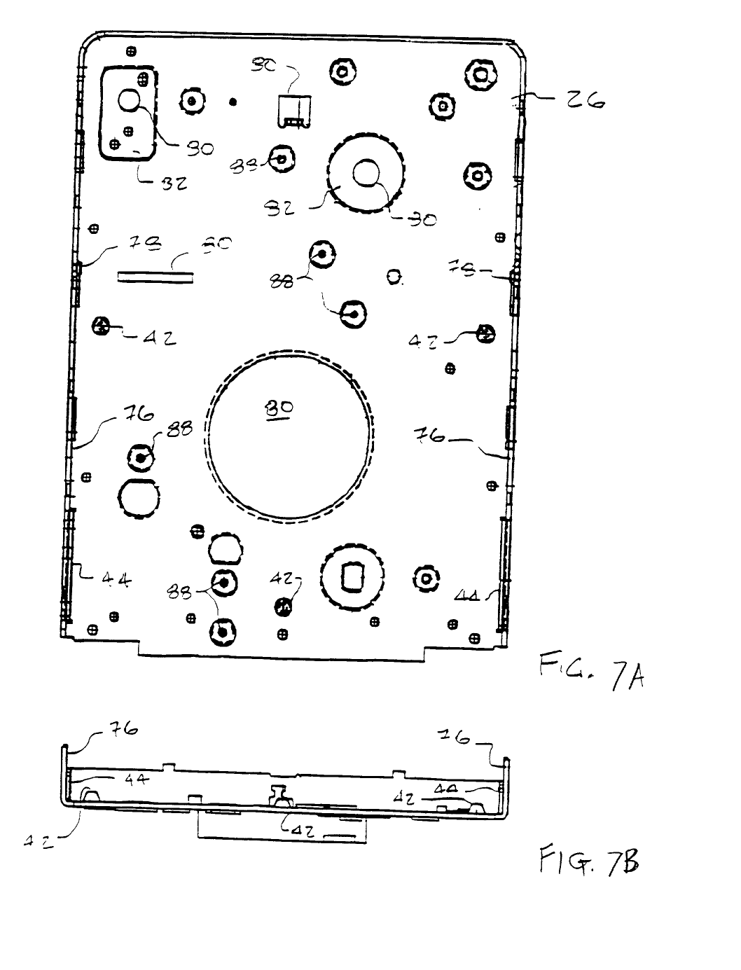

A cartridge for use with internal drive 20 is illustrated in FIGS. 5 and 5A. Generally, cartridge 60 includes a front edge 62 and rear edge 64. A disk 66 (see FIG. 7B) is disposed within cartridge 60, and access to the disk is provided through a door 68. A detent 70 along rear edge 64 of cartridge 60 mates with latch 46 to restrain the cartridge within the receptacle of the drive, while rear side indentations 72 are sized to accommodate side rails 44 to allow cartridge 60 to drop vertically into the receptacle.

Side edges 74 of cartridge 60 are fittingly received between side walls 76 of base 26, as illustrated in FIG. 6. This generally helps maintain the lateral position of cartridge 60 within base 26 throughout the insertion process. Stops 78 in sidewall 76 stop forward motion of the cartridge once the hub of disk 66 is aligned with spindle drive 34, at which point rails 44 are also aligned with rear indents 72. Hence, the cartridge drops roughly vertically from that position, which helps accurately mate the hub of the disk with the spindle drive.

The structure of base 26 can be seen most clearly in FIGS. 6, 7A, and 7B. Base 26 generally comprises a stamped sheet metal structure, ideally being formed of stainless steel. Openings 80 accommodate the spindle drive, data transmission cables, component mounting fasteners, and the like. Openings 80 are substantially formed during the stamping process, but may optionally be modified afterward to provide threaded openings, etc. Mounting pads 82 are also generally defined by the stamp tools, so that head load ramp 38, the head support structure (which generally includes voice coil motor 30 and head support arm 50, as illustrated in FIG. 4), and spindle drive 34 are substantially located relative to each other.

Bosses 42 and side wall 76 are also formed by clamping the sheet metal stock between the male and female tool parts, while side rails 44 and stops 78 may be formed by independently movable tool portions. Hence, the cartridge engaging surfaces and component mounting pads are positioned on base 26 simultaneously during the relatively rapid stamping process, rather than individually machining each of these surfaces.

Once base 26 is stamped to shape, the various components may be mounted to the base to assembly the disk drive. Voice coil motor 30 and arm 50, which together support head 32 (see FIG. 4) are mounted directly to their associated pad 82. Spindle drive 34 will then be bonded to the base material which extends downward from its associated opening 80. The driving member will rotate about a fixed position, rather than telescoping axially to engage the disk within the cartridge. The position of the spindle drive assembly can be adjusted during the bonding process using a gauge to align the disk on the spindle drive with the motion of heads 32.

Head load ramp 38 is also mounted on an associated stamped pad 82 of base 26. The head load ramp will preferably flex about a central fulcrum 84. This facilitates adjustment of a height of the head load ramp over the base using a rear screw 86, as more fully described in co-pending U.S. patent application Ser. No. 08/970,282, filed concurrently herewith (Attorney Docket No. 18525-000800) and assigned to the present assignee, the full disclosure of which is incorporated herein by reference. This allows the height of the head load ramp adjacent the disk to be easily adjusted so as to smoothly transfer the heads between the recording surface and a “park” position along the head load ramp.

Also formed during the stamping process are linkage mounts 88. Release linkage 36 and head retract linkage 40 will be mounted to linkage mounts 88 using rivets or other fasteners which accommodate the sliding and/or pivoting of the linkage members, as appropriate.

Heads 32 will often be separated from the spinning recording surface by a thin layer of air. More specifically, the data transfer head often glides over the recording surface on an “air bearing,” a thin layer of air which moves with the rotating disk. Although recording densities are generally enhanced by minimizing the thickness of this air bearing, often referred to as the glide height, glide heights which are too low may lead to excessive contact between the head and the disk surface, which can decrease the reliability of the recording system. To avoid a head crash (in which the data transfer head contacts and damages the disk), the disk drive system of the present system will generally position heads 32 on head load ramp 38 whenever the disk is rotating at insufficient velocity to maintain a safe glide height.

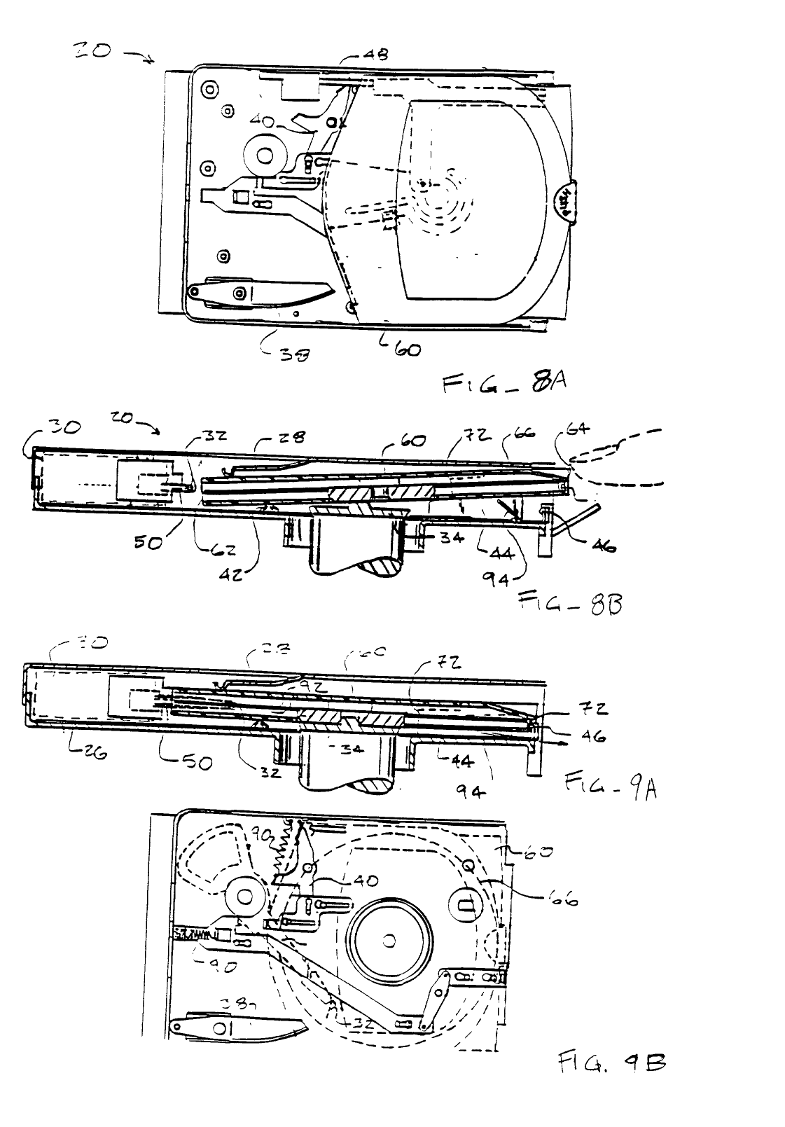

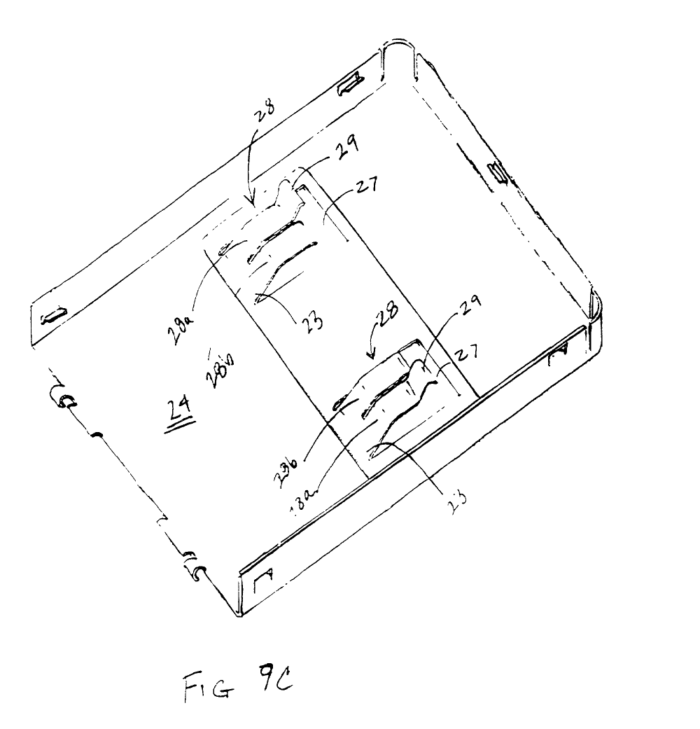

Referring now to FIGS. 8A-9C, arm 50 pivotally supports heads 32. When no cartridge is disposed in internal drive 20 and no power is supplied to voice coil motor 30, biasing springs of head retract linkage 40 and release linkage 36 urge arm 50 to a parked position on head load ramp 38. As cartridge 60 is inserted into the receptacle of internal drive 20, the cartridge actuates head retract linkage 40 so that the voice coil motor is free to pivot the arm from the parked position.

Cover springs 28 are manufactured or formed directly into the disk drive cover 24 and extend from the cover 24 toward the receptacle of internal drive 20 (see FIG. 4). Openings 27, preferably being opposed relative to an axis of insertion of the cartridge 60, are cut into housing cover 24 to define the spring structures. At least a portion of the cover material from the openings is not removed, but remains attached to the housing cover to provide the material for the springs. The cover material will typically be stainless steel or some other resilient material. To prevent the introduction of foreign elements into the internal disk drive through the openings, the openings can be subsequently covered with a plastic or similar material.

As shown in FIG. 9C, the cover material is split into two elongate strips 28a, 28b which extend in cantilever from the cover attach point 23 toward the receptacle. The springs preferably angle inward relative to the axis of insertion. Each spring 28 is adapted to slidingly engage the cartridge 60 to facilitate insertion and removal of the cartridge from the receptacle. Advantageously, the force applied by the springs 28 to the cartridge 60 will be no more than necessary to bias the cartridge toward the receptacle.

In a preferred embodiment, the elongate strips 28a each have a protrusion 29 adjacent to the free end of the strips. This protrusion 29 is adapted to resist introduction of the cartridge 60 so that the two opposed springs promote even advancement of the cartridge relative to the axis of insertion.

Specifically, during insertion, cover springs 28 urge forward edge 62 of cartridge 60 downward, while rear edge 64 remains elevated (so long as the cartridge rides along rails 44). As cartridge 60 slides into the receiver, biasing spring 90, attached to head retract linkage 40 is tensioned. Biasing spring 102 is generally overcome manually during insertion of the cartridge.

Once cartridge 60 is inserted so that disk 66 is substantially aligned axially with spindle drive 34, rear side indentations 72 (see FIG. 5) allow rear edge 64 of the cartridge to drop downward below rails 44. This downward movement is opposed by base springs 94. These base springs generally comprise simple wire structures screwed or otherwise fastened to base 26, and the upward urging force imposed on cartridge 60 by the base springs is again manually overcome during insertion.

As base springs 94 are compressed against base 26, latch 46 slides into detent 80, so that the latch restrains cartridge 60 within the receiver of internal drive 20. Simultaneously, spindle drive 34 aligns with and engages the hub of disk 66, with centering alignment and driving engagement between the spindle drive and the disk generally being facilitated by a protruding, tapering nose on a magnetic chuck of the spindle drive and a corresponding counter sunk armature at the hub of disk 66.

As described hereinabove, the door of the cartridge opens automatically during insertion of the cartridge. Actuation of head retract linkage 40 during insertion also frees arm 50 to move heads 32 from head load ramp 38 to recording surfaces 92 along the major surfaces of disk 66.

While cartridge 60 is disposed within the receptacle of drive 20, the position of the cartridge is generally maintained by engagement between the surfaces of the cartridge and the stamped surfaces of base 26. More specifically, cover springs 28 and latch 46 hold cartridge 60 in contact with bosses 42, thereby ensuring alignment between the major surfaces of the cartridge and the disk drive structure. The fore and aft position of the cartridge is generally maintained by engagement between side rails 44 and rear indentation 72, with head retract linkage 40 biasing these two elements against each other. As described above, the sidewalls of base 26 fittingly receive side edges of cartridge 60, so that the position of the cartridge within the receptacle is substantially fully constrained. The tolerance of the positioning of the cartridge within drive 20 should be sufficient so that the disk within the cartridge is rotatable within the cartridge housing, and so that the heads (as supported by the head support structure) have free access to the recording surfaces of the disk.

As described above, cartridge 60 is held in the receiver of internal drive 20 by engagement of latch 46 with detent 70. Voice coil motor 30 may effect release of the cartridge by engagement between a tab of arm 50 and a corresponding tab on release linkage 36. Expulsion of the disk from the receptacle of internal drive 20 is effected after the disk has spun down with heads 32 safely parked along head load ramp 38. Voice coil motor 30 actuates release linkage 36 so as to disengage latch 46 from detent 80.

When the latch is disengaged, engagement between rails 44 and indents 72 initially prevents the cartridge from sliding along the plane of the disk. Instead, base springs 94 urge rear edge 64 of cartridge 60 upward, disengaging spindle drive 34 substantially axially from the hub of the disk. Once these driving structures are safely disengaged, biasing spring 90 of head retract linkage 40 urges cartridge 60 out of the receiver, and the head retract linkage also ensures that arm 50 is safely positioned with heads 32 along head load ramp 38. Generally, the biasing system will slide the cartridge rearward so that a portion of the cartridge extends from the drive, and so that the cartridge can be easily manually removed and replaced by the user.

While the exemplary embodiment has been described in some detail, by way of example and for clarity of understanding, a variety of modifications, changes, and adaptations will be obvious to those of skill in the art. For example, the invention has described rocker arms or hinge assemblies used to urge open the disk drive access panel door. It may be possible to replace the hinges with a pulley system that will use the inherent mechanical advantage of the pulley to open the door. In another example, the actuation assembly can be adapted for ejection of a disk cartridge from the disk drive system. An eject button may activate the assembly causing the contraction forces to manipulate mechanisms which will, in turn, release the cartridge. Another example can include the internal drive, which can be urged forward at an angle through the receptacle portion of the housing to be in an elevated position to receive the disk cartridge. Therefore, the scope of the present invention is limited solely by the appended claims.

What is claimed is:

1. An actuation assembly comprising:
a mechanical member comprising an alloy, said alloy member to undergo an internal change in structure thereby producing a force set within the mechanical member; and
a pivot member moved by said force, said mechanical member applying said force to said pivot member.

2. The actuation assembly of claim 1, wherein the alloy member is made of a shape-memory alloy taken from a group of alloys comprising of the products Nitinol™ and Flexinol™.

3. A hard disk drive comprising an actuation assembly and a housing having a receptacle which removably receives a cartridge, a cover formed of a cover material and a front loading panel disposed over the receptacle, the actuation assembly comprising:
a hinge assembly; and
a drive assembly comprising an alloy member which is coupled to the hinge assembly; and
a power supply which generates an electrical current, the current used to sufficiently raise the temperature of the alloy member causing the alloy member to undergo an internal change in structure thereby producing a force set within the alloy member, the force being sufficient to actuate movement of the hinge assembly.

4. The actuation assembly of claim 3, the hinge assembly comprising:
a first mechanical arm coupled to a pivot rod; and
a second mechanical arm coupled to the pivot rod, wherein the contraction force causes rotation of the pivot rod which causes the arms to rotate, the pivot rod defining the axis of rotation.

5. The actuation assembly of claim 3, the hinge assembly comprising: a single hinge coupled to the loading panel.

6. The actuation assembly of claim 3, wherein the drive assembly further comprises:
a cam assembly comprising:
a cam rotatable between an initial position and first and second extended positions;
a cam spring in slidable contact with a portion of the cam member surface, whereby the cam spring engages the portion of the cam member surface to locate the cam member in each of said positions; and
a biasing member coupled to the cam member to return the alloy member to the initial position following the removal of the alloy member force.

7. The actuation assembly of claim 3, the drive assembly further comprising:
a lever, having a first end and a second end, rotatable about a pivot location between a first position and a second position, the first end coupled to the alloy member and the second end coupled to a biasing spring, the biasing spring to return the alloy member to an initial position following the removal of the alloy member force.

8. The actuation assembly of claim 3, the drive assembly further comprising a cable having a first end coupled to the alloy member.

9. The actuation assembly of claim 3, wherein the power supply is activated or deactivated by a switching mechanism.

10. The actuation assembly of claim 9, wherein deactivation of the current causes the internal structure of the alloy member to return to its initial state thereby removing the alloy member force.

11. The actuation assembly of claim 3, wherein the alloy member is made of a shape-memory alloy taken from a group of alloys comprising of the products Nitinol™ and Flexinol™.

12. The actuation assembly of claim 3, wherein the alloy member is disposed within a protective shield.

13. The actuation assembly of claim 3 further comprising a pair of hinge assemblies coupled to said loading panel.

14. A method for manipulating members of a removable hard disk drive, the removable hard disk drive comprising a housing having a receptacle which removably receives a cartridge, a cover formed of a cover material and a front loading panel disposed over the receptacle, the method comprising:
selecting an alloy member which undergoes an internal change in structure when subjected to a change in temperature;
generating an electrical current, the current used to sufficiently raise the temperature of the alloy member to produce a force set within the alloy member; and
moving a component of the drive using the alloy member force.

15. The method of claim 14, wherein the alloy member comprises a shape-memory alloy taken from the group comprising of Nitinol™ and Flexinol™.

16. A method comprising:
supplying energy to an alloy member causing the alloy member to undergo an internal change in structure thereby producing a force set within the alloy member; and
actuating movement of a device by coupling said force to said device.

17. The method of claim 16, wherein the alloy member comprises a shape-memory alloy taken from the group comprising of Nitinol™ and Flexinol™.

18. A method for fabricating an actuation assembly for a hard disk drive comprising a housing having a receptacle which removably receives a cartridge, a cover formed of a cover material and a front loading panel disposed over the receptacle, the method comprising:
selecting an alloy member, having a first end and a second end, which can undergo an internal change in structure, which produces a force within the alloy member;
affixing said first end of the alloy member to a pivot assembly; and
affixing said second end of the alloy member to a hinge mechanism, the hinge mechanism being coupled to a loading panel.

19. A method as in claim 18, wherein the pivot assembly comprises:
positions;
a cam spring in slidable contact with a portion of the cam member surface, whereby the cam spring engages the portion of the cam member surface to locate the cam member in each of said positions; and
a biasing member coupled to the cam member to return the alloy member to the initial position following the removal of the alloy member force.

20. A disk drive system for use with a removable disk cartridge, the disk drive system comprising a housing having a receptacle which removably receives the cartridge, the housing having a cover formed of a cover material and a door, the door being coupled to an actuation assembly comprising:
a first arm coupled at a first end to the proximal end of a pivot shaft and coupled at a second end to the door;
a second arm coupled at a first end to the distal end of a pivot shaft and coupled at a second end to a biasing mechanism;
a shape-memory alloy wire mechanically coupled to the second end of the second arm and a position on the housing;
a power supply activated by a switch positioned on the housing, wherein the power supply generates a current; and
an electrical connection for applying the current to the wire, wherein the wire is heated by the current which causes the wire to contract generating a pulling force which is adapted to actuate the first and second arms.

21. The actuation assembly of claim 20, wherein the alloy material comprises a shape-memory alloy taken from the group of alloys comprising of Nitinol™ and Flexinol™.
